(19) United States
(12) Patent Application Publication
(10) Pub. No.: US 2025/0196084 A1
(43) Pub. Date: Jun. 19, 2025

(54) ISOLATING A REACTION CHAMBER FROM A COMBUSTION CHAMBER

(71) Applicant: EKONA POWER INC., Burnaby (CA)

(72) Inventors: Donald W. KENDRICK, Bellevue, WA (US); Timothy Scott COLEMAN, Port Moody (CA); David Aaron LEBOE, Vancouver (CA); Scott Cameron GRAY, Ottawa (CA)

(21) Appl. No.: 18/980,300

(22) Filed: Dec. 13, 2024

Related U.S. Application Data
(60) Provisional application No. 63/618,125, filed on Jan. 5, 2024.
(60) Provisional application No. 63/610,923, filed on Dec. 15, 2023.

(51) Int. Cl. B01J 4/00; F16K 3/06

(52) U.S. Cl. CPC B01J 4/008; F16K 3/06

(57) ABSTRACT

A valve is moved from an open position, in which fluid flow from a combustion chamber to a reaction chamber is permitted along a fluid flow path, to a closed position in which fluid flow from the combustion chamber to the reaction chamber is prevented along the fluid flow path. With the valve in the closed position, the reaction chamber is loaded with a feedstock and the combustion chamber is loaded with a combustible gas mixture. After loading the reaction chamber with the feedstock and loading the combustion chamber with the combustible gas mixture, the combustible gas mixture is combusted to generate combustion product gases, and the valve is moved to the open position. The combustion product gases flow along the fluid flow path from the combustion chamber to the reaction chamber, mix with a feedstock, and cause decomposition of the feedstock.

### CROSS-REFERENCE TO RELATED APPLICATION

This application claims priority from U.S. Provisional Patent Application Ser. No. 63/610,923 filed on Dec. 15, 2023 and U.S. Provisional Patent Application Ser. No. 63/618,125 filed on Jan. 5, 2024, the entire disclosures of which are part of the disclosure of the present application and are hereby incorporated by reference in their entireties.

### FIELD

The present disclosure relates to thermal pyrolysis and in particular to devices, methods, and systems for isolating a reaction chamber from a combustion chamber.

### BACKGROUND

Thermal pyrolysis is a method by which a feedstock gas, such as a hydrocarbon, is decomposed without oxygen into its constituent elements (in the case of a hydrocarbon, carbon and hydrogen). The decomposition is triggered by sufficiently raising the temperature of the feedstock gas to a point at which the chemical bonds of the elements of the feedstock gas break down.

Pyrolysis may be achieved by bringing the feedstock gas into thermal contact with a hot fluid. In one example, combustion product gases, formed as a result of combusting a combustible fuel, may be mixed with the feedstock gas. At high-enough temperatures, the mixing of the hot fluid with the feedstock gas, and the transfer of thermal energy from the hot fluid to the feedstock gas, is sufficient to cause the feedstock gas to break down and decompose.

According to one type of feedstock reactor, a combustor is fluidly connected, via one or more nozzles, to a reaction chamber in which the feedstock is decomposed. Combustion products generated in a combustion chamber of the combustor are expelled under high pressure through orifices in the nozzles. However, interaction between both volumes (i.e., the feedstock in the reaction chamber and the combustible gas mixture in the combustion chamber) can complicate the loading of the combustion chamber and the reaction chamber. For example, there exists the potential for ingestion of pre-heated feedstock into the combustor and/or spilling of the combustible gas mixture into the reaction chamber. The former may result in undesirable auto-ignition of the combustible gas mixture in the combustor prior to complete filling. This may reduce the eventual yields of hydrogen and carbon.

One solution is to use an inert buffer of methane to prevent cross-contamination of the gases, but this buffer absorbs energy and diminishes the effectiveness of the combustor. Furthermore, ingestion of the feedstock into the combustor will alter the fuel-air ratio and thereby alter the combustion intensity, yielding further undesirable effects.

### SUMMARY

According to a first aspect of the disclosure, there is provided a method of operating a feedstock reactor comprising a reaction chamber connected by a fluid flow path to a combustion chamber, comprising: moving a valve from an open position, in which fluid flow from the combustion chamber to the reaction chamber is permitted along the fluid flow path, to a closed position in which fluid flow from the combustion chamber to the reaction chamber is prevented along the fluid flow path; with the valve in the closed position, loading the reaction chamber with a feedstock and loading the combustion chamber with a combustible gas mixture; after loading the reaction chamber with the feedstock and loading the combustion chamber with the combustible gas mixture: combusting the combustible gas mixture to generate one or more combustion product gases; and moving the valve to the open position, wherein the one or more combustion product gases flow along the fluid flow path from the combustion chamber to the reaction chamber, mix with the feedstock, and cause decomposition of the feedstock.

Moving the valve to the open position may occur before combusting the combustible gas mixture.

The valve may be a rotary valve and moving the valve between the open and closed positions may comprise rotating the valve.

Moving the valve to the open position may comprise the one or more combustion product gases causing the valve to move to the open position and thereby allowing the one or more combustion product gases to flow along the fluid flow path from the combustion chamber to the reaction chamber.

The valve may be a check valve biased to the closed position and operable to move to the open position in response to a pressure exerted on the check valve exceeding a threshold.

The method may further comprise, with the valve in the closed position, opening an exhaust valve to vent one or more gases from the combustion chamber.

Opening the exhaust valve may be performed before loading the reaction chamber with the feedstock and loading the combustion chamber with the combustible gas mixture.

According to a first aspect of the disclosure, there is provided a feedstock reactor comprising: a reaction chamber for receiving a feedstock; a combustion chamber connected to the reaction chamber by a fluid flow path and for receiving a combustible gas mixture; and a valve movable between an open position, in which fluid flow from the combustion chamber to the reaction chamber is permitted along the fluid flow path, and a closed position in which fluid flow from the combustion chamber to the reaction chamber is prevented along the fluid flow path.

The feedstock reactor may further comprise a controller comprising circuitry and configured to: move the valve from the open position to the closed position; with the valve in the closed position, operate one or more compressors to load the reaction chamber with the feedstock and load the combustion chamber with the combustible gas mixture; after loading the reaction chamber with the feedstock and loading the combustion chamber with the combustible gas mixture: move the valve to the open position; and operate an igniter to initiate combustion of the combustible gas mixture and thereby generate one or more combustion product gases that flow along the fluid flow path from the combustion chamber to the reaction chamber, mix with the feedstock, and cause decomposition of the feedstock.

The controller may be further configured, after loading the reaction chamber with the feedstock and loading the combustion chamber with the combustible gas mixture, and prior to operating the igniter, to move the valve to the open position.

The valve may be a rotary valve, and the controller may be further configured to rotate the rotary valve between the open and closed positions.

The valve may be a check valve biased to the closed position and operable to move to the open position in response to a pressure exerted on the check valve exceeding a threshold.

The feedstock reactor may further comprise a fluid nozzle connected to the combustion chamber and extending into the reaction chamber, wherein the fluid flow path extends through the fluid nozzle, and wherein the valve is positioned in the fluid nozzle.

The controller may be further configured, before loading the reaction chamber with the feedstock and loading the combustion chamber with the combustible gas mixture, and with the valve in the closed position, to open an exhaust valve to vent one or more gases from the combustion chamber.

This summary does not necessarily describe the entire scope of all aspects. Other aspects, features and advantages will be apparent to those of ordinary skill in the art upon review of the following description of specific embodiments.

### DRAWINGS

Embodiments of the disclosure will now be described in detail in conjunction with the accompanying drawings of which:

FIG. 1 is a schematic diagram of a feedstock reactor according to an embodiment of the disclosure;

FIG. 2A shows a nozzle forming part of a combustor, according to an embodiment of the disclosure;

FIG. 2B shows detail in the end of a nozzle according to an embodiment of the disclosure;

FIG. 3 is a schematic diagram of a nozzle including a rotatory valve, according to an embodiment of the disclosure;

FIG. 4 is a flow diagram of a method of decomposing a feedstock, according to an embodiment of the disclosure.

FIG. 5 is a cross-sectional view of a combustor according to an embodiment of the disclosure;

FIG. 6 is a cross-sectional view of a check valve according to an embodiment of the disclosure; and

FIG. 7 is a flow diagram of a method of decomposing a feedstock, according to another embodiment of the disclosure.

### DETAILED DESCRIPTION

The present disclosure seeks to provide a novel devices, methods, and systems for isolating a reaction chamber from a combustion chamber. While various embodiments of the disclosure are described below, the disclosure is not limited to these embodiments, and variations of these embodiments may well fall within the scope of the disclosure which is to be limited only by the appended claims.

Generally, embodiments of the disclosure relate to devices, methods, and systems for performing pyrolysis of a feedstock gas, such as natural gas or a hydrocarbon gas, such as methane. Such methods of pyrolysis, as well as example feedstock gas reactors that may be used for such pyrolysis, are described in further detail in PCT Publication No. WO 2020/118417, herein incorporated by reference in its entirety.

Some embodiments of the disclosure are directed to a feedstock reactor including a valve, such as a rotary valve, that is movable between open and closed positions for selectively allowing the flow of gases between a combustion chamber a reaction chamber of the feedstock reactor.

Some embodiments of the disclosure are directed to a feedstock reactor including a valve, such as a check valve or a one-way valve, that is movable between open and closed positions for selectively allowing the flow of gases between a combustion chamber and a reaction chamber of the feedstock reactor.

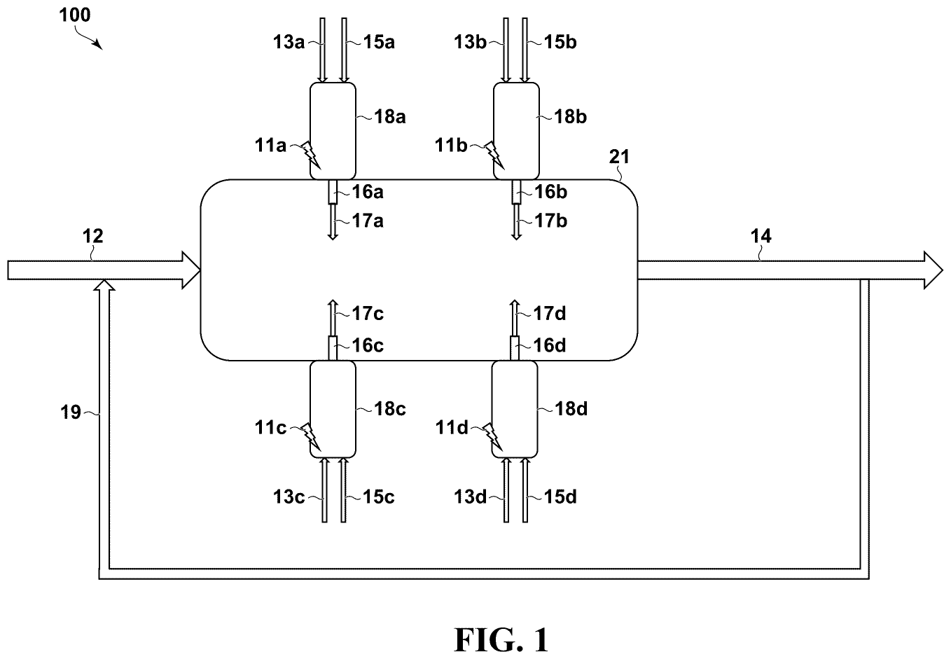

Turning to FIG. 1, there is shown an embodiment of a feedstock reactor 100 used to decompose feedstock, according to an embodiment of the disclosure.

Reactor 100 includes a reaction chamber 21 connected to multiple combustors 18a-18d (which collectively may be referred to as combustors 18). Each combustor 18 includes a combustion chamber into which is fed an oxidant 13a-13d (for example, pure oxygen or air) and a fuel 15a-15d (for example, unreacted feedstock). Each combustor 18 further includes an igniter 11a-11a for triggering combustion of the fuel and the oxidant within the combustion chamber. According to some embodiments, the fuel and oxidant may be delivered to combustors 18 in a pre-mixed state (which may be referred to as a “premix”).

During a reaction cycle of reactor 100, a feedstock 12 (such as a hydrocarbon, for example methane) is fed under pressure into reaction chamber 21. At the same time, combustors 18a-18d are filled with a combustible gas mixture comprising a mixture of fuel 15a-d (e.g. methane or natural gas) and oxidant 13a-d. Once reaction chamber 21 and combustors 18 have been loaded with feedstock 12 and combustible gas mixture, respectively, igniters 11a-d are triggered and cause combustion of the combustible gas mixture in combustors 18 which results in the generation of hot combustion products 17a-d. Combustion products 17a-d flow under pressure through nozzles 16a-d that are connected to combustors 18 and that extend into the interior volume of reaction chamber 21. Combustion products 17a-d are ejected out of nozzles 16a-d and mix with feedstock 12 within reaction chamber 21.

As a result of the flow of combustion products 17a-d into reaction chamber 21, thermal energy is transferred from combustion products 17a-d to the feedstock. Energy is also transferred from combustion products 17a-d to the feedstock via dynamic compression of the feedstock as a result of the pressure increasing within reaction chamber 21 in response to the flow of hot, pressurized combustion products into reaction chamber 21. Past a certain point, the increase in the temperature of the feedstock is sufficient to drive decomposition or pyrolysis of the feedstock. In the case of methane, for example, the decomposition takes the following form:

CH₄+energy→C+2H₂

The pyrolysis reaction generates reaction products 14 that are extracted from reaction chamber 21. A portion of reaction products 14 is recycled back to reaction chamber 21 for future reaction cycles. Reaction products 14 may comprise one or more of hydrogen, nitrogen, and carbon. The unwanted products may be primarily carbon dioxide, nitrogen, and water. The recycled gas mixture may comprise primarily unreacted natural gas, hydrogen, nitrogen, and carbon monoxide.

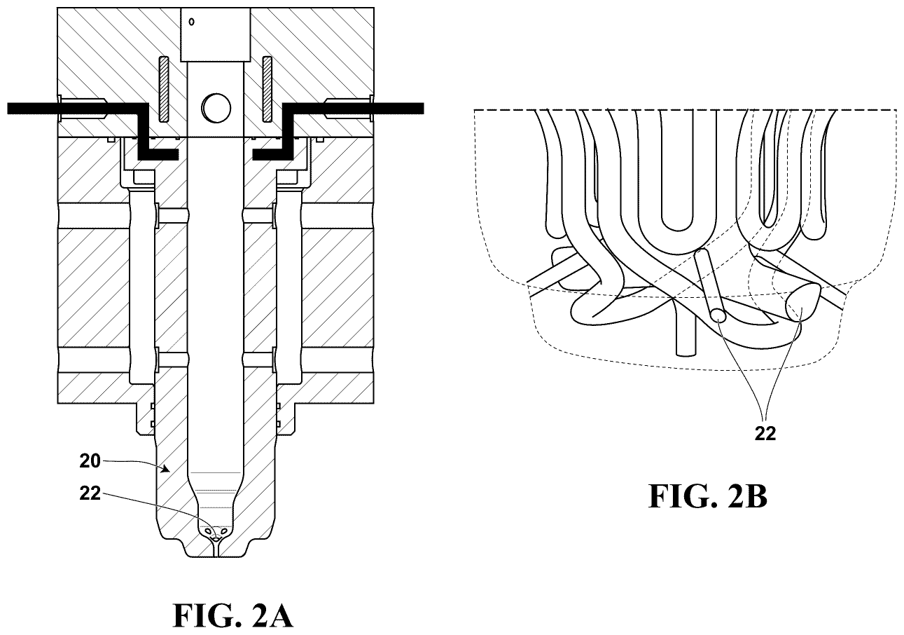

Turning to FIG. 2A, there is shown in more detail an example of a nozzle 20 extending from the combustion chamber into the reaction chamber. At the distal end of nozzle 20 are provided orifices 22 through which the hot combustion products flow into the reaction chamber to elevate the feedstock's temperature to a pre-pyrolysis state.

FIG. 2B shows a more detailed view of an example nozzle tip including orifices 22 and the contours of the nozzle tip.

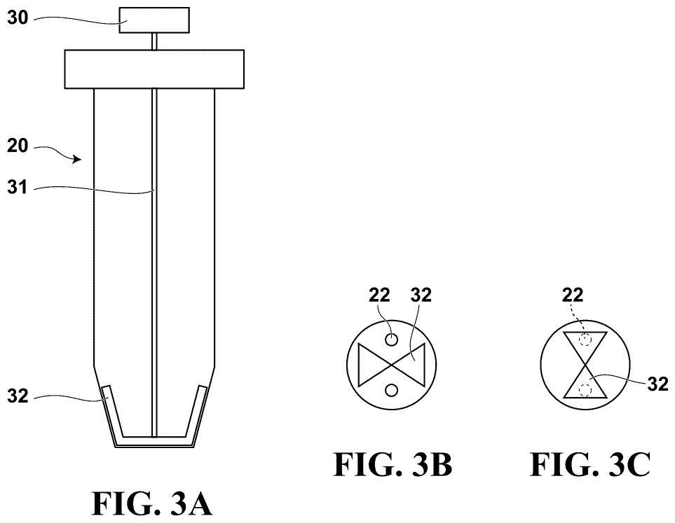

As can be seen in FIG. 3, according to some embodiments of the disclosure, a rotary valve 32 is provided at the distal end of nozzle 20. Rotary valve 32 is formed to the contours of the distal end of nozzle 20 (i.e., the shape of rotary valve 32 closely matches or corresponds to the shape of the distal end of nozzle 20). Rotary valve 32 is controllable by an actuator 30 connected to an axial shaft 31 that may be manipulated exterior to the combustor to rotate valve 32 between open and closed positions, for example by rotating rotate valve 32 back and forth and by 90° each rotation. In the open position, nozzle orifices 22 are exposed and permit the flow of combustion products into the reaction chamber, whereas in the closed position nozzle orifices 22 are sealed and the flow of combustion products into the reaction chamber is prevented.

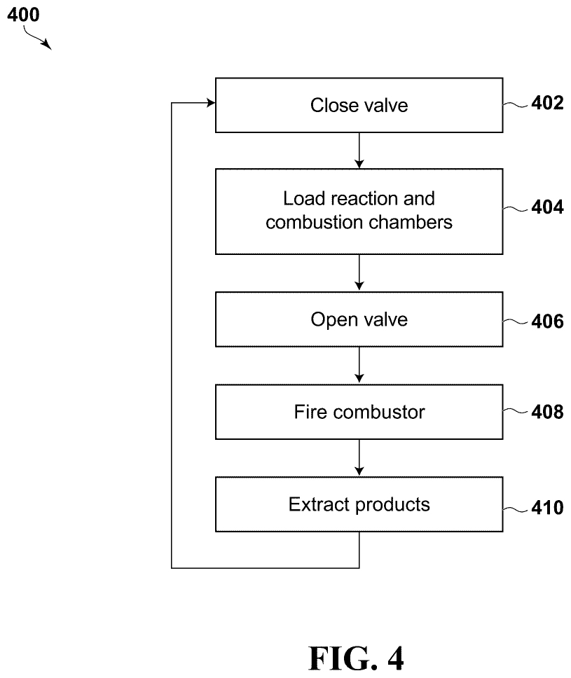

Turning to FIG. 4, there is shown an example method 400 of operating a feedstock reactor that uses a rotary valve as described above.

At block 402, the valve is moved from an open position, in which fluid flow from the combustion chamber to the reaction chamber is permitted, to a closed position in which fluid flow from the combustion chamber to the reaction chamber is prevented.

At block 404, with the valve in the closed position, the reaction chamber is loaded with a feedstock and the combustion chamber with loaded with a combustible gas mixture.

At block 406, after loading the reaction chamber with the feedstock and loading the combustion chamber with the combustible gas mixture, the valve is moved to the open position.

At block 408, the combustible gas mixture is combusted (for example, by triggering an igniter) to generate one or more combustion product gases that flow from the combustion chamber to the reaction chamber, mix with the feedstock, and cause decomposition of the feedstock.

At block 410, reaction products formed as a result of the pyrolysis may be extracted by opening an outlet of the reaction chamber. The method may then proceed back to block 402 at which the next reaction cycle begins.

Operation of the valve may be controlled by a suitable controller (such as a microprocessor) comprising circuitry. The controller, or some other controller, may control the loading of the combustion and reaction chambers by controlling compressors or similar devices.

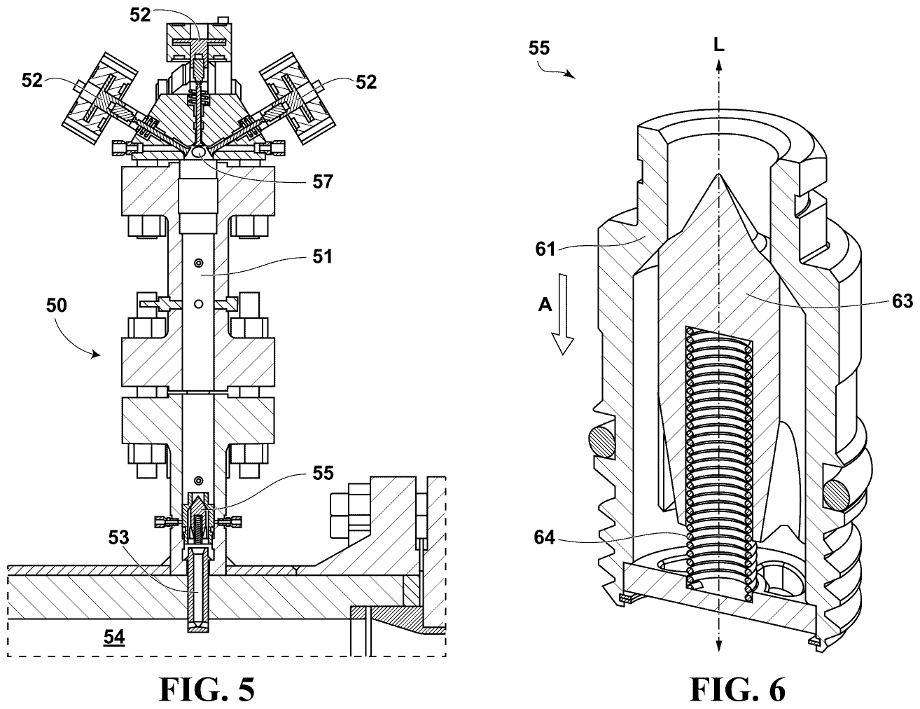

Turning to FIG. 5, there is shown a cross-sectional view of a combustor 50 comprising a combustion chamber 51, inlet valves 52 for fuel and oxygen, an exhaust valve 57, and a nozzle 53 connected to combustion chamber 51 and extending into a reaction chamber 54 of the reactor. Positioned between combustion chamber 51 and nozzle 53 is a check valve 55, shown in more detail in FIG. 6.

As can be seen in FIG. 6, check valve 55 comprises a valve seat 61 and a movable valve portion 63 that is movable along a longitudinal axis L of check valve 55. Valve portion 63 is biased by a spring 64 into a closed position relative to valve seat 61. When sufficient pressure is exerted on valve portion 63 in the direction of arrow A (for example, when the pressure within combustion chamber 51 exceeds the biasing force of spring 64), valve portion 63 is moved in the direction of arrow A and opens a fluid flow path extending through a gap (not shown) defined between valve seat 61 and valve portion 63. When in the open position, combustion products may flow from combustion chamber 51 to nozzle 53 via check valve 55, and are then ejected under pressure into reaction chamber 54 through orifices provided in the distal end of nozzle 53.

It shall be recognized that other types of valves (such as valves that do not necessarily rotate, or that are not necessarily one-way valves) may be used to control the opening and closing of the fluid flow path(s) between the combustion chamber and the reaction chamber. Any valve used in the feedstock reactor may be manufactured from high-strength metallics (e.g., refractory metals) or the like.

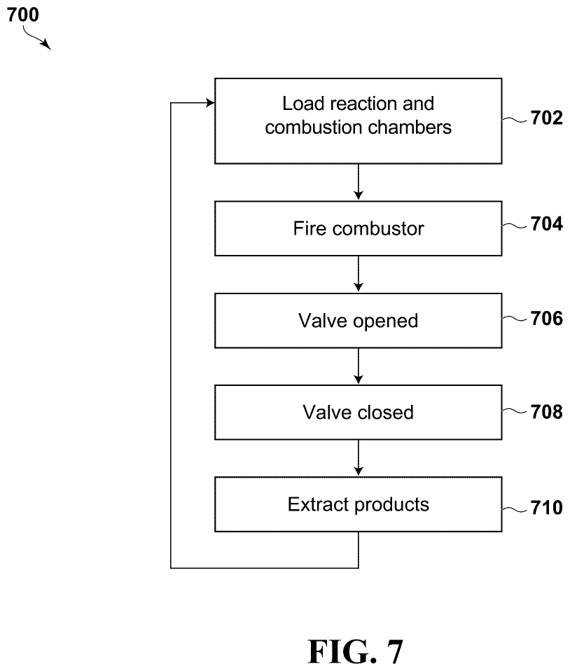

Turning to FIG. 7, there is shown an example method 700 of operating a feedstock reactor that uses a one-way or check valve as described above.

At the beginning of a reaction cycle, the check valve is closed. Before loading the combustion chamber with fuel and oxidant, the exhaust valve in the combustor is opened to vent the combustion chamber to atmospheric pressure. Any feedstock within the reaction chamber (e.g., remaining from the previous reaction cycle) cannot flow into the combustion chamber because of the closed check valve.

At block 702, the reaction chamber is loaded with feedstock and, after closing of the exhaust valve, the combustion chamber is loaded with a combustible gas mixture (i.e., fuel (such as methane) and an oxidant (such as oxygen)) to a desired pressure. This pressure may be at or below the pressure of the feedstock in the reaction chamber.

At block 704, after loading the reaction chamber with the feedstock and loading the combustion chamber with the combustible gas mixture, the fuel and oxidant valves are closed, and the combustible gas mixture is combusted (for example, by triggering an igniter) to generate one or more combustion product gases.

At block 706, the rise in pressure due to combustion causes the check valve to open (i.e., when the pressure in the combustion chamber is greater than the pressure in the reaction chamber plus the biasing force of the check valve), leading to hot combustion products flowing through the nozzle and into the reaction chamber. The hot combustion products mix with the feedstock and cause decomposition of the feedstock.

At block 708, as the hot combustion products flow out of the combustion chamber and into the reaction chamber, the pressure within the combustion chamber drops and the check valve returns to its closed position.

At block 710, reaction products formed as a result of the pyrolysis may be extracted by opening an outlet of the reaction chamber. The method may then proceed back to block 702 at which the next reaction cycle begins.

Advantageously, the check valve may prevent mixing of the fuel and the oxidant with the feedstock during the loading phase (block 702). Furthermore, when opening the exhaust valve, feedstock within the reaction chamber is prevented from flowing into the combustor. Further still, the combustion chamber may be loaded to a lower pressure than that of the reaction chamber (to mitigate the high detonation pressures generated in the combustion chamber)—this may assist in lowering the temperature of the combustion chamber walls.

Operation of the exhaust valve (in the combustor) and the outlet (in the reaction chamber) may be controlled by a suitable controller (such as a microprocessor) comprising circuitry. The controller, or some other controller, may control the loading of the combustion and reaction chambers by controlling compressors or similar devices.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of operating a feedstock reactor comprising a reaction chamber connected by a fluid flow path to a combustion chamber, comprising:
moving a valve from an open position, in which fluid flow from the combustion chamber to the reaction chamber is permitted along the fluid flow path, to a closed position in which fluid flow from the combustion chamber to the reaction chamber is prevented along the fluid flow path;
with the valve in the closed position, loading the reaction chamber with a feedstock and loading the combustion chamber with a combustible gas mixture;
after loading the reaction chamber with the feedstock and loading the combustion chamber with the combustible gas mixture:
combusting the combustible gas mixture to generate one or more combustion product gases; and
moving the valve to the open position,
wherein the one or more combustion product gases flow along the fluid flow path from the combustion chamber to the reaction chamber, mix with the feedstock, and cause decomposition of the feedstock.

2. The method of claim 1, wherein moving the valve to the open position occurs before combusting the combustible gas mixture.

3. The method of claim 1, wherein the valve is a rotary valve and wherein moving the valve between the open and closed positions comprises rotating the valve.

4. The method of claim 1, wherein moving the valve to the open position comprises the one or more combustion product gases causing the valve to move to the open position and thereby allowing the one or more combustion product gases to flow along the fluid flow path from the combustion chamber to the reaction chamber.

5. The method of claim 4, wherein the valve is a check valve biased to the closed position and operable to move to the open position in response to a pressure exerted on the check valve exceeding a threshold.

6. The method of claim 1, further comprising, with the valve in the closed position, opening an exhaust valve to vent one or more gases from the combustion chamber.

7. The method of claim 6, wherein opening the exhaust valve is performed before loading the reaction chamber with the feedstock and loading the combustion chamber with the combustible gas mixture.

8. A feedstock reactor comprising:
a reaction chamber for receiving a feedstock;
a combustion chamber connected to the reaction chamber by a fluid flow path and for receiving a combustible gas mixture; and
a valve movable between an open position, in which fluid flow from the combustion chamber to the reaction chamber is permitted along the fluid flow path, and a closed position in which fluid flow from the combustion chamber to the reaction chamber is prevented along the fluid flow path.

9. The feedstock reactor of claim 8, further comprising a controller comprising circuitry and configured to:
move the valve from the open position to the closed position;
with the valve in the closed position, operate one or more compressors to load the reaction chamber with the feedstock and load the combustion chamber with the combustible gas mixture;
after loading the reaction chamber with the feedstock and loading the combustion chamber with the combustible gas mixture:
move the valve to the open position; and
operate an igniter to initiate combustion of the combustible gas mixture and thereby generate one or more combustion product gases that flow along the fluid flow path from the combustion chamber to the reaction chamber, mix with the feedstock, and cause decomposition of the feedstock.

10. The feedstock reactor of claim 9, wherein the controller is further configured, after loading the reaction chamber with the feedstock and loading the combustion chamber with the combustible gas mixture, and prior to operating the igniter, to move the valve to the open position.

11. The feedstock reactor of claim 8, wherein:
the valve is a rotary valve; and
the controller is further configured to rotate the rotary valve between the open and closed positions.

12. The feedstock reactor of claim 8, wherein the valve is a check valve biased to the closed position and operable to move to the open position in response to a pressure exerted on the check valve exceeding a threshold.

13. The feedstock reactor of claim 8, further comprising a fluid nozzle connected to the combustion chamber and extending into the reaction chamber, wherein the fluid flow path extends through the fluid nozzle, and wherein the valve is positioned in the fluid nozzle.

14. The feedstock reactor of claim 8, wherein the controller is further configured, before loading the reaction chamber with the feedstock and loading the combustion chamber with the combustible gas mixture, and with the valve in the closed position, to open an exhaust valve to vent one or more gases from the combustion chamber.
